(19) United States
(12) Patent Application Publication
(10) Pub. No.: US 2013/0206782 A1
(43) Pub. Date: Aug. 15, 2013

(54) Disposable Sleeve For Vehicle Cup Holder

(71) Applicant: James Kyooje Lee, Oak Park, CA (US)

(72) Inventor: James Kyooje Lee, Oak Park, CA (US)

(21) Appl. No.: 13/764,694

(22) Filed: Feb. 11, 2013

Related U.S. Application Data
(60) Provisional application No. 61/633,417, filed on Feb. 11, 2012.

(51) Int. Cl. B60N 3/10

(52) U.S. Cl. CPC B60N 3/10
USPC 220/737

(57) ABSTRACT

One example embodiment is directed to a disposable sleeve for a vehicle cup holder. The sleeve includes a rigid ring portion that includes a horizontal lip or flange, and a flexible, cup-shaped portion that is attached to the ring. Preferably, the bottom surface of the lip and the cup-shaped portion include non-residual adhesive for removably-securing the sleeve to a vehicle's cup holder. In this respect, if I user spills liquid, food, or other dirt inside the sleeve, the sleeve can be easily removed and replaced.

### RELATED APPLICATIONS

This application claims priority to U.S. Provisional Application Ser. No. 61/633,417 filed Feb. 11, 2012 entitled Automobile Cup Holder Disposable Sleeve, which is hereby incorporated herein by reference in its entirety.

### BACKGROUND OF THE INVENTION

Most modern vehicles come equipped with cup holders that allow a driver or passenger to safely store their beverage cup or mug. While these cup holders are convenient for storing beverage containers, their cup-shape also tends to collect liquid spills, food particles, dust, and other dirt. Since most cup holders are non-removably built into a vehicle's interior, vacuum cleaners, rags, and brushes are typically used for cleaning. However, the size and shape of these cup holders often prevent these cleaning implements from removing all dirt and liquid stains.

### SUMMARY OF THE INVENTION

One example embodiment is directed to a disposable sleeve for a vehicle cup holder. The sleeve includes a semi-rigid ring portion that includes a horizontal lip or flange, and a flexible, cup-shaped portion that is attached to the ring. Preferably, the bottom surface of the lip and the cup-shaped portion include non-residual adhesive for removably-securing the sleeve to a vehicle's cup holder. In this respect, if a user spills liquid, food, or other dirt inside the sleeve, the sleeve can be easily removed and replaced.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a top view of a disposable cup sleeve for a vehicle according to the present invention;

FIG. 2 is a side view of the disposable cup sleeve of FIG. 1;

FIG. 3 is a top perspective view of the disposable cup sleeve of FIG. 1;

FIG. 4 is a bottom perspective view of the disposable cup sleeve of FIG. 1;

FIG. 5 is a side view of the disposable cup sleeve of FIG. 1 within a vehicle cup holder; and,

FIG. 6 is a side view of an alternate embodiment of a disposable cup sleeve for a vehicle according to the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

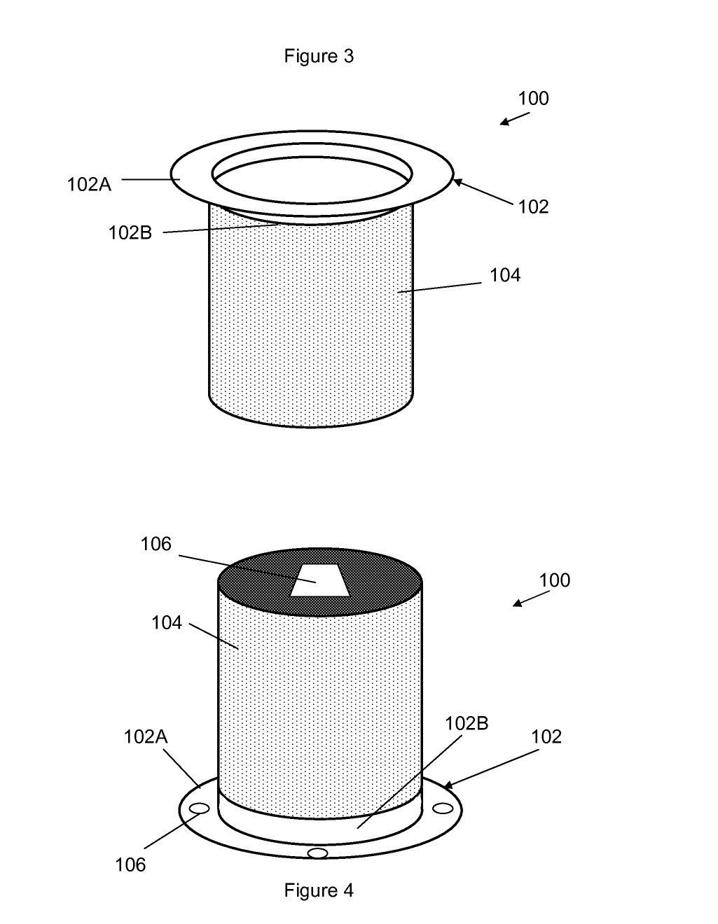

FIGS. 1-5 illustrate various views of a disposable cup sleeve 100 that can be placed in a vehicle cup holder 10. When the cup sleeve 100 becomes dirty, stained, or damaged, the vehicle owner can simply remove the sleeve 100 and replace it with a new one. In this respect, the vehicle owner is spared the time and hassle associated with merely cleaning the vehicles cup holder, especially if that cup holder is not removable.

The sleeve 100 includes a top ring member 102 having a horizontal lip 102A and a vertical tube or ring portion 102B. Preferably, the ring member 102 is composed of a semi-rigid material such as metal or plastic (e.g., automotive-grade plastic found in the interior of many vehicles). In one example, the ring 102 has an outer diameter within a range of about 3 inches to about 4 inches (e.g., 3, 3.5, or 4 inches). In another example, the ring member 102 has an inner diameter within a range of about 2.5 inches and about 3.5 inches (e.g., 2.5, 3, or 3.5 inches). In another example, the lip 102A has a width within a range of about 3/16 of an inch and about 5/16 of an inch. Though the ring is shown as being circular, it is considered within the scope of the invention that the ring is custom-shaped to fit the various cup holders of different automobile makes and models.

The sleeve 100 further comprises a flexible portion 104 that has a generally tubular shape with a closed end and an open end (i.e., forms a generally “cup-shape”). The open end of the flexible portion 104 is connected to the vertical ring portion 102B via adhesives or other physical connection mechanisms. Preferably, the flexible portion has a diameter matching or similar to the inner diameter of the ring member 102 and a length within a range of about 2.5 inches and about 4 inches. In one embodiment, the flexible portion 104 is composed of a flexible material, such as a flexible plastic (e.g., very-low-density polyethylene or similar polyethylene types) or a paper-based material. In an alternate embodiment, the flexible portion 104 may be composed of a more rigid material (e.g., plastic or cardboard) having a plurality of alternating folds (i.e., accordion-folds) that allow the portion 104 to compress to a smaller size against the ring member 102.

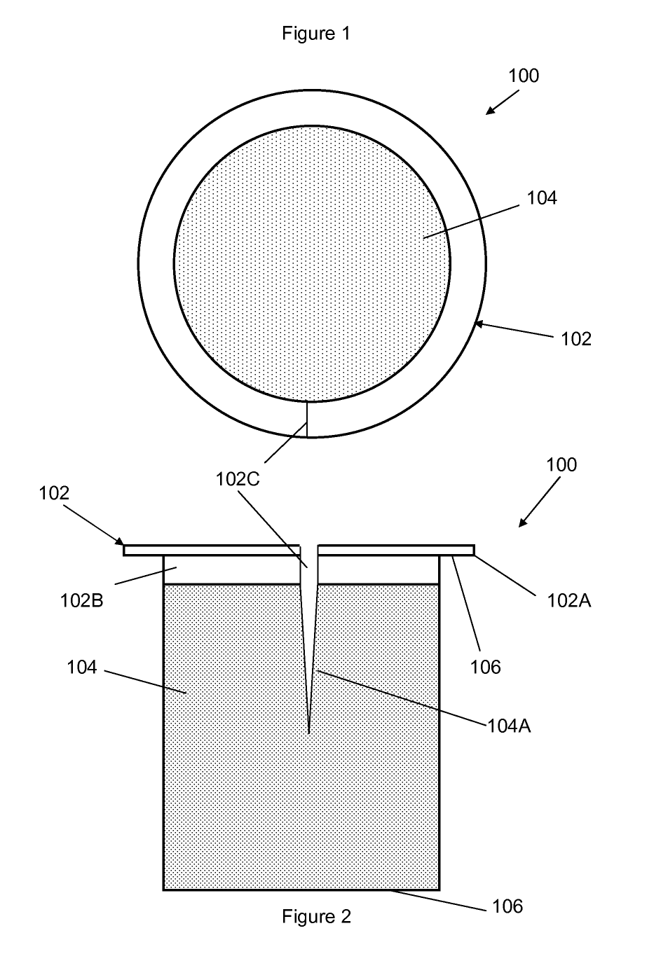

In one embodiment, the sleeve 100 can be a fixed size. In another embodiment, the sleeve 100 may be configured to change diameter to accommodate different sized cup holders. For example, as best seen in FIGS. 1 and 2, the top ring member 102 may variably accommodate different diameter cup holders via a vertical cut 102C or opening through the lip 102A and ring portion 102B. The flexible portion 104 may also have a gap or opening aligned with the cut 102C, such as the inverted triangle-shaped opening 104A (see FIG. 2). This opening 104A can extend along only a portion of the height of the flexible portion 104 (e.g., about 1.5 inches) or can extend along most or even all of the height of the flexible portion 104.

In the case of cup holders having a larger diameter than the diameter of the ring member 102, the ring 102 can be opened to better match the cup holder. Conversely, the ends of the ring 102 formed by the cut 102C can be moved together or overlapped to accommodate cup holders with a smaller diameter than that of the ring 102. Optionally, the ring 102 may include a locking adjustment mechanism (not shown) located near the cut 102C to maintain the ring 102 in a desired diameter. For example, the ring 102 may include a ratcheting mechanism similar to those used on cable ties.

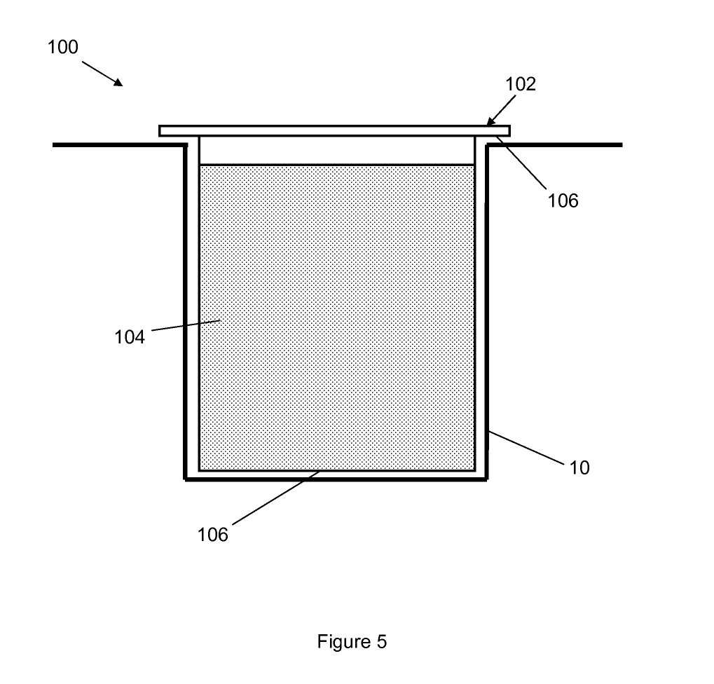

Preferably, the sleeve 100 includes adhesive 106 on one or more of its surfaces to help maintain the sleeve 100 within a vehicles cup holder 10 during use. In one example shown in FIGS. 4 and 5, the sleeve 100 includes adhesive on a bottom surface of the lip 102A and on the bottom surface of flexible portion 104. The adhesive 106 may be located on smaller discrete areas as shown in the Figures or may located over the entire lip 102A and portion 104. Preferably, a non-residual adhesive may be used, such as super tack adhesive.

The ring 102 and flexible portion 104 may have matching or different colors selected from a variety of popular car interior colors (e.g., black, red, grey, beige). In one embodiment, the ring 102 and flexible portion 104 are colored to match an interior color scheme of a specific vehicle (e.g., the sleeve may be packaged with labeling that indicates that the sleeve matches the color scheme of a particular make, model, year, and interior color of a vehicle). In this respect, a vehicle owner may purchase sleeves 100 colored specifically for their make, model, year, and interior colors of their vehicle. Similarly, vehicle manufacturers can provide a purchaser of a new vehicle with matching sleeves 100 for a specific car at purchase.

In use, the user removes any protective film covering the adhesive 106 on the surfaces of the sleeve 100 and then inserts the sleeve 100 into the vehicle cup holder 10. The adhesive 106 maintains the bottom of the lip 102A with the surrounding surface of the cup holder and the portion 104 with the bottom surface of the cup holder 10.

Once soiled or damaged, the user may remove the sleeve 100 from the cup holder 10 and replace it with a new sleeve 100.

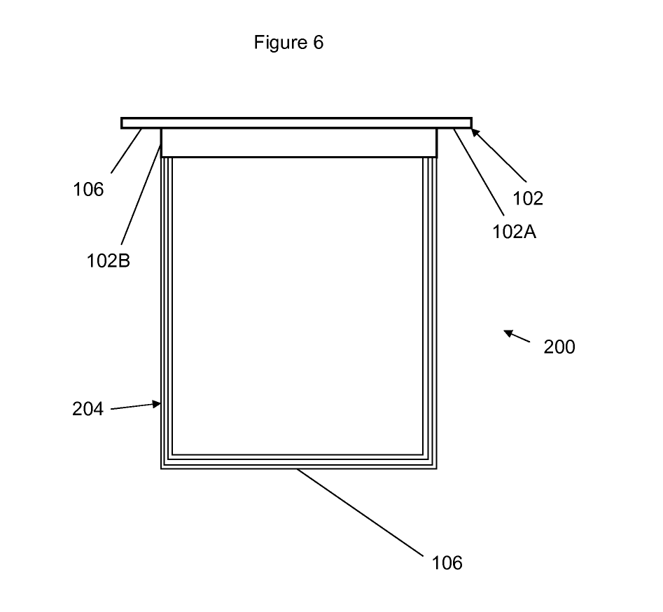

FIG. 6 illustrates an alternate embodiment of the sleeve 200 which includes a plurality of flexible portions 204 that are all removably-attached to the ring member 102 (e.g., perforations or an easily separable adhesive). Optionally, each of these flexible portions 204 include adhesive on their lower surface to adhere them to the next flexible portion 204, much like “sticky notes”. When one of the flexible portions becomes soiled or damaged, the user can remove one of the layers from the sleeve 200, exposing the clean flexible portion layer beneath it.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A disposable sleeve for a cup holder, comprising:
a ring member having a horizontal lip; and,
a flexible cup-shaped portion connected to said ring member near an open end of said cup-shaped portion.

2. The disposable sleeve of claim 1, further comprising adhesive located on an underside of said disposable sleeve.

3. The disposable sleeve of claim 2, wherein said adhesive is located on a surface of said ring member.

4. The disposable sleeve of claim 2, wherein said adhesive is located on a surface of said flexible cup-shaped portion.

5. The disposable sleeve of claim 2, wherein said adhesive is located on a surface of said ring member and on a surface of said flexible cup-shaped portion.

6. The disposable sleeve of claim 1, wherein an outer diameter of said ring member is within a range of about 3 inches and about 4 inches.

7. The disposable sleeve of claim 1, wherein an inner diameter of said ring member is within a range of about 2.5 inches and about 3.5 inches.

8. The disposable sleeve of claim 1, wherein an inner diameter of said ring member is within a range of about 2.5 inches and about 3.5 inches and an outer diameter of said ring member is within a range of about 3 inches and about 4 inches.

9. The disposable sleeve of claim 1, wherein said flexible cup-shaped portion comprises a plurality of alternating folds.

10. The disposable sleeve of claim 1, wherein said flexible cup-shaped portion comprises a plurality of layers that are removably-adhered to each other.

11. The disposable sleeve of claim 1, wherein said ring member and said cup-shaped portion are adjustable to increase or decrease in diameter.

12. A method of using a disposable sleeve, comprising:
providing a sleeve;
placing said sleeve into a cup holder of a vehicle;
removably-adhering a lip of a ring member around a surface surrounding said cup holder; and,
removably-adhering a bottom surface of a cup-shaped portion to a bottom of said cup holder.

13. The method of claim 12, further comprising removing said disposable sleeve from said cup holder.

14. The method of claim 12, wherein said placing said sleeve into said cup holder is preceded by expanding a length or diameter of said cup-shaped portion.

15. The method of claim 12, wherein said providing a sleeve further comprises providing a sleeve that is color-matched to an interior color scheme of said vehicle.

16. A disposable sleeve kit, comprising:
a disposable sleeve having a flexible cup portion and a horizontal lip portion, and an adhesive located on an underside of said sleeve.

17. The disposable sleeve kit of claim 16, wherein said disposable sleeve is colored to match the interior of a make, model and year of a vehicle.

18. The disposable sleeve kit of claim 16, further comprising packaging specifying a make, model, and year of a vehicle that matches a color of said sleeve.

19. The disposable sleeve kit of claim 16, wherein said adhesive is located on an underside of said horizontal lip portion.

20. The disposable sleeve kit of claim 16, wherein said cup portion and said lip portion include a vertical gap to allow an increase or decrease in the diameter of said disposable sleeve.
